(19) United States
(12) Patent Application Publication
(10) Pub. No.: US 2008/0086224 A1
(43) Pub. Date: Apr. 10, 2008

(54) TRIPLE- DOUBLE INDEX RATING AND CLASSIFICATION SYSTEM

(76) Inventor: William Tsinberg, Rego Park, NY (US)

Correspondence Address: MEREDITH & KEYHANI, PLLC, 330 MADISON AVE., 6TH FLOOR, NEW YORK, NY, 10017, US

(21) Appl. No.: 11/871,128

(22) Filed: Oct. 11, 2007

Related U.S. Application Data
(63) Continuation of application No. 11/186,179, filed on Jul. 21, 2005.
(60) Provisional application No. 60/634,947, filed on Dec. 10, 2004.

(51) Int. Cl. G06F 19/00

(52) U.S. Cl. 700/91; 473/415

(57) ABSTRACT

A method of rating and classifying players of a game comprising the steps of: evaluating a players rebounding proficiency to provide a rebounds per game for a player; evaluating a players shooting proficiency to provide a points per game for a player; evaluating a players passing proficiency to provide assists per game for a player; summing the points per game, assists per game and rebounds per game for the player to provide a triple double rating; and providing a grouping according to the triple double rating to provide a triple double index.

This application is a continuing application of Ser. No. 11/186,179 filed Jul. 21, 2005 and currently pending, which claims priority to provisional patent application No. 60/634,947 as filed Dec. 10, 2004 and titled, “Triple double index basketball rating and classification system”.

The present invention relates generally to methods and systems for rating and classifying players of a game. The methods and systems described herein may be particularly suited for the game of basketball, but is intended to be applicable to players of any game, to provide a rating and classification for a players or a team that sorts them by a single ranking, quotient and classification regardless of position, generation or duration of play. The triple-double index rating and classification system, and it's components separately or in any combination, may be applied to a single game, any part, or any group of games, and a single player or any group of players, and also displayed on any display medium (including a statboard or scoreboard).

The game of basketball has a continually expanding roster. As the roster of teams and players expands, it is useful to compare past and present players. Conventional ratings and classification systems are often based on secondary criteria and lack a clear method of interpretation. Also, many methods are based upon complicated mathematical formulas, which are not easily comprehended by the average sports fan and commentator. Another problem with prior art methods of rating players is that they provide a poor frame of reference by vague or undiversified brackets, as well as values that are not transferable across distinctions of position and era of play. Also, because of their complexity they are difficult to apply over brief durations such as game by game or quarter by quarter. Another problem is that they lack the descriptive quality of graphics, symbol or other accompaniment for practical accessibility and appeal.

Examples of prior art methods of rating players includes the approximate value index, the efficiency index and the euroleague index rating.

The approximate value index is credits^{(3/4)}/21. The term credit is the sum of points, rebounds, assists, steals, and blocks minus field goals missed, free throws missed and turnovers. The efficiency index is (((points+rebounds+steals+assists+blocks)−((field goals attempted-field goals made)+(free throws attempted−free throws made)+turnovers))/games). The euroleague index rating=(points+assists+rebounds+blocks+steals+fouls drawn+free throws made+field goals made+3 point field goals made−turnovers−blocks against−fouls−free throws attempted−field goals attempted−3 point field goals attempted).

While such prior art methods provide a rating for player, such methods do not provide an improved, integrated and summary evaluation of players regardless of their position, generation, or duration of play. Also, they fail to provide a representative formula with well defined bracket plateaus or boundaries for grouping players and teams. Also, there has been a long felt need within the art to provide well proportioned numerical values that are transferable across distinctions such as position, generation and duration of play. One example may be that they do not encompass play prior to 1973 because criteria such as steals and blocks were not recorded prior to 1973.

Accordingly, the present invention provides methods and systems to evaluate players and teams accurately, summarily, comparatively, diversely, objectively and graphically.

### SUMMARY OF THE INVENTION

The present invention relates generally to methods and systems for evaluating players and teams.

According to one aspect of the present invention, a method of rating and classifying players of a game, the method comprising the steps of: evaluating a players rebounding proficiency to provide a rebounds per game for a player; evaluating a players shooting proficiency to provide a points per game for a player; evaluating a players passing proficiency to provide assists per game for a player; summing the points per game, the assists per game and rebounds per game for the player to provide a triple double rating; and providing a grouping according to the triple double rating to provide a triple double index.

According to another aspect of the present invention, a method of rating and classifying players of a game is disclosed, the method comprising the steps of: evaluating a players rebounding proficiency to provide a rebounds per game for a player; evaluating a players shooting proficiency to provide a points per game for a player; evaluating a players passing proficiency to provide assists per game for a player; summing the points per game, the assists per game and the rebounds per game for the player to provide a triple double rating; providing a grouping according to the triple double rating to provide a triple double index; and dividing the triple double rating by a minutes value to provide a secondary sum.

According to yet another aspect of the present invention, a method of rating and classifying players of a game is provided, the method comprising the steps of: evaluating a players rebounding proficiency to provide a rebounds per game for a player; evaluating a players shooting proficiency to provide a points per game for a player; evaluating a players passing proficiency to provide assists per game for a player; summing the points per game, the assists per game and the rebounds per game for the player to provide a triple double rating; providing a grouping according to the triple double rating to provide a triple double index; providing a graphic according to the triple double index for the player; providing a descriptive according to the triple double index for the player; dividing the triple double rating by a minutes value to provide a secondary sum.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention; and

FIG. 6 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

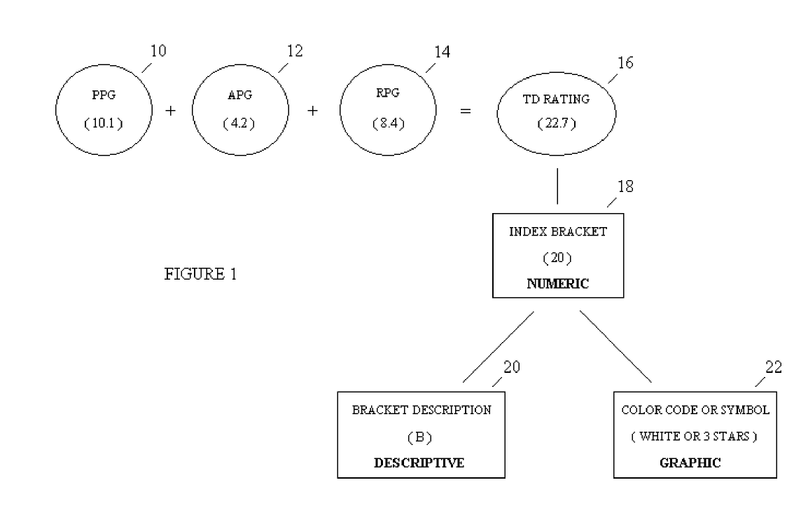

According to the present invention, as depicted in FIG. 1, a method of rating and classifying players of a game is provided, the method comprising the steps of: evaluating a players rebounding proficiency to provide a rebounds per game for a player (14); evaluating a players shooting proficiency to provide a points per game for a player (10); evaluating a players passing proficiency to provide assists per game for a player (12); summing the points per game (10), assists per game (12) and rebounds per game (14) for the player to provide a triple double rating (16); and providing a grouping (18) according to the triple double rating to provide a triple double index. The method may be non-subjective and entirely statistically based. That is to say, it does not require any input based upon subjective criteria and is only based upon results.

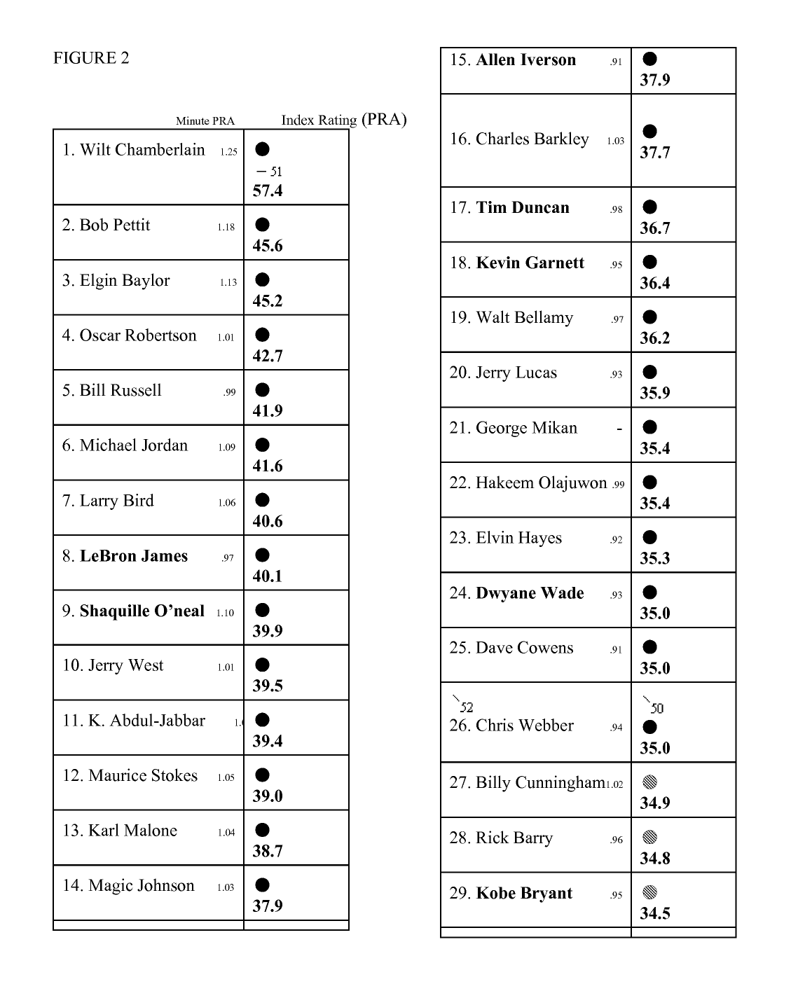

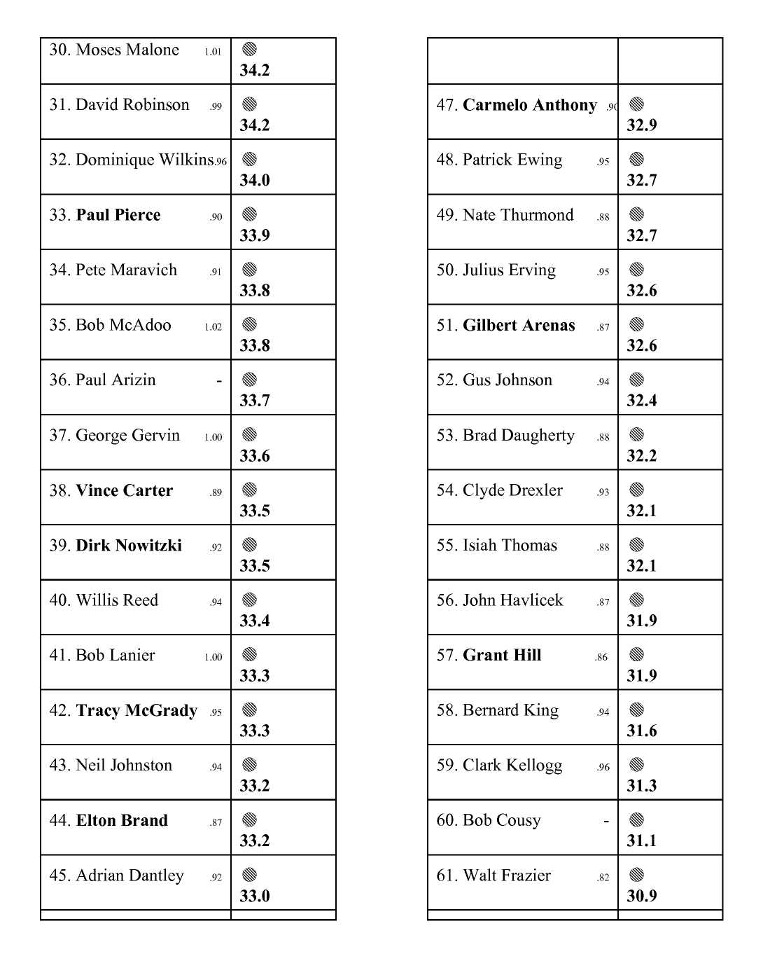

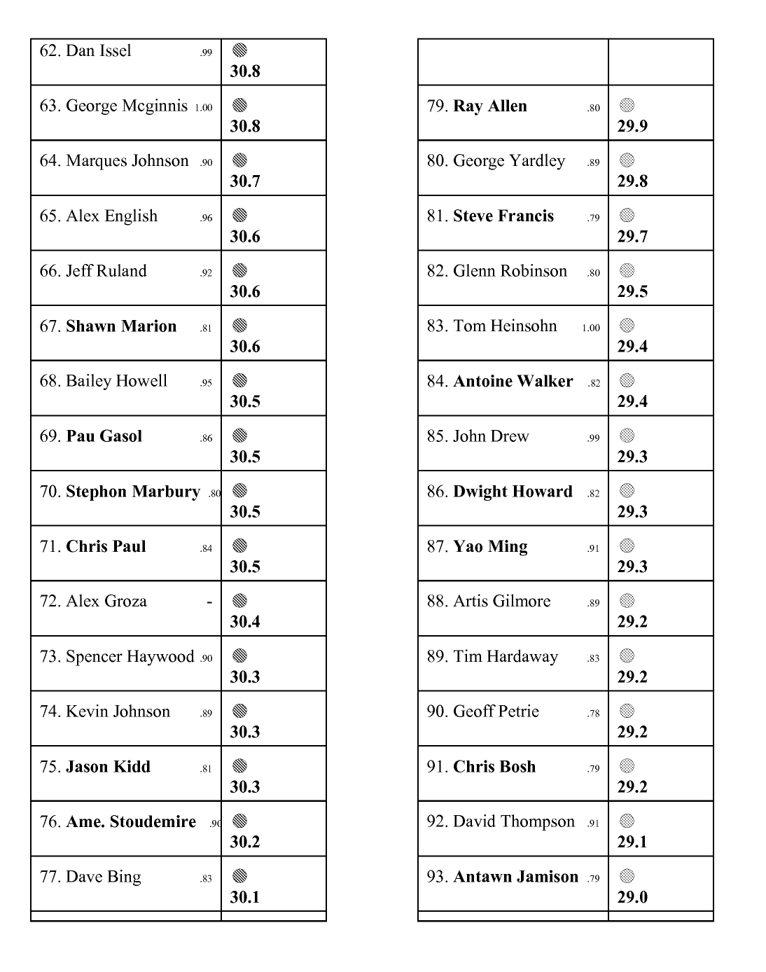

FIG. 2 depicts a list of players according to their triple double rating (50) and secondary sum (52). The secondary sum (52) is arrived at by dividing the triple double rating by the number of minutes played. As shown, the higher the triple double rating, the better rated the player. For example, Wilt Chamberlain has the highest triple double rating of 57.4 and the highest secondary sum of 1.25. The term sum and quotient may be interchangeable.

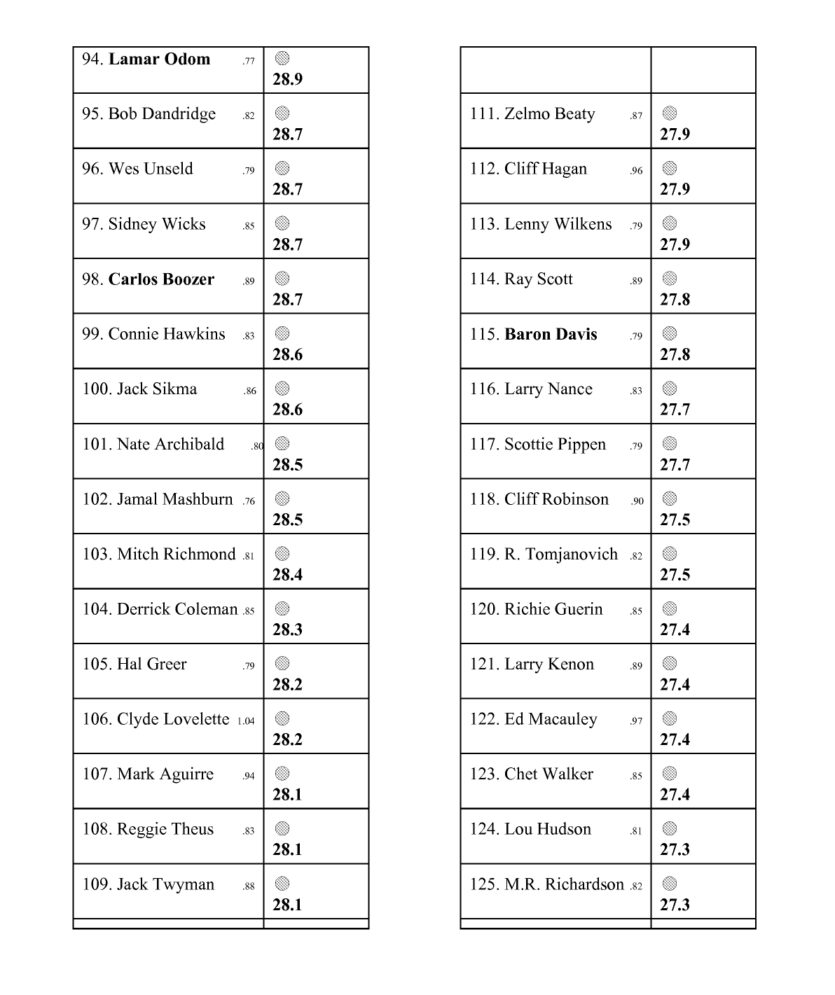

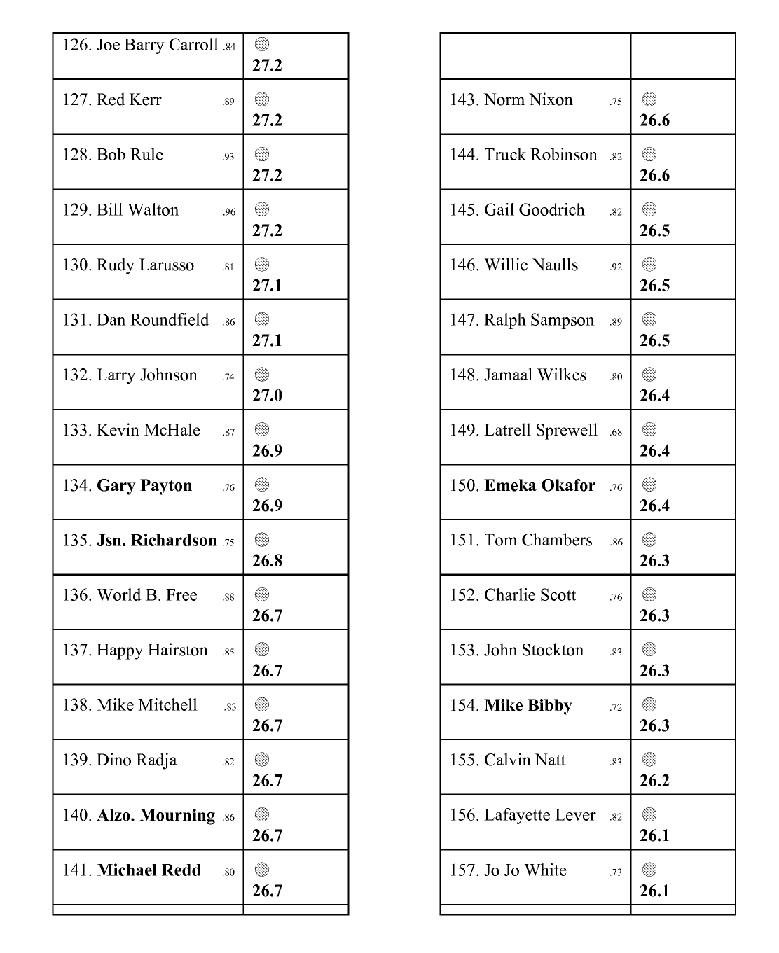

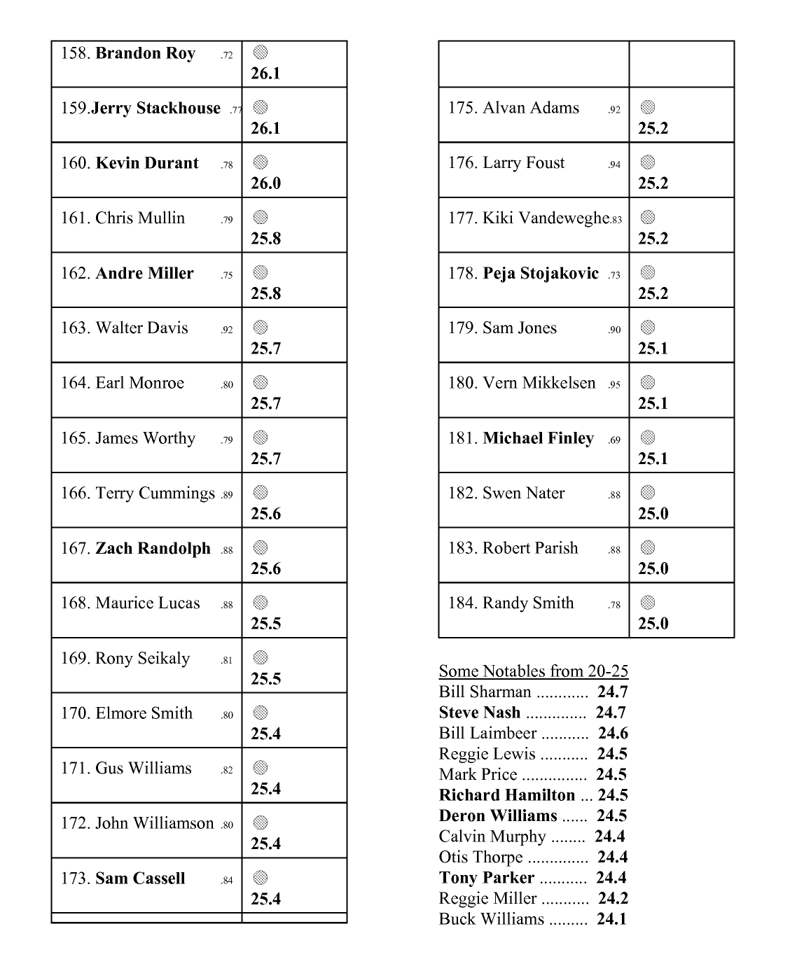

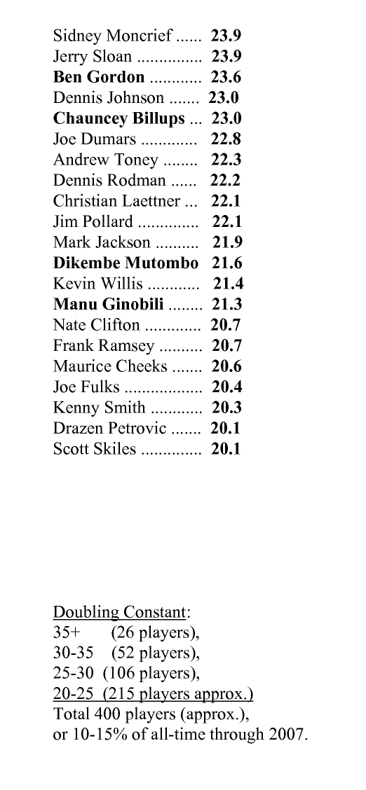

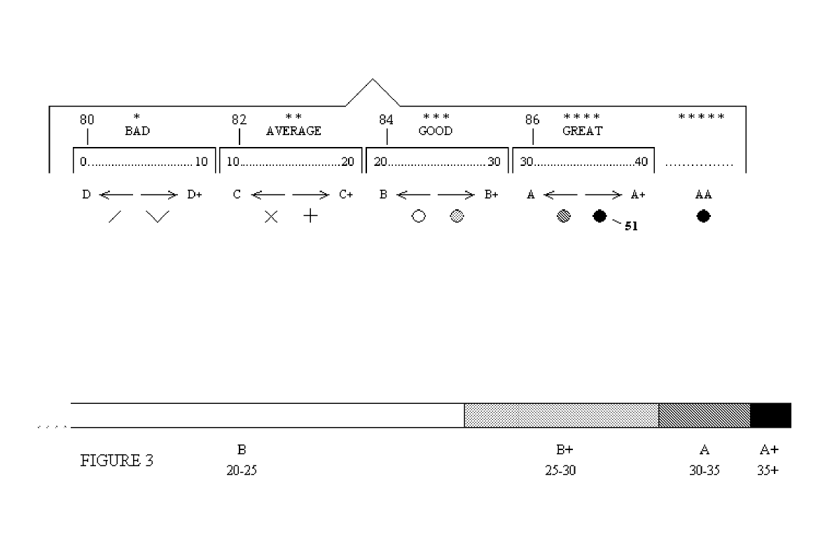

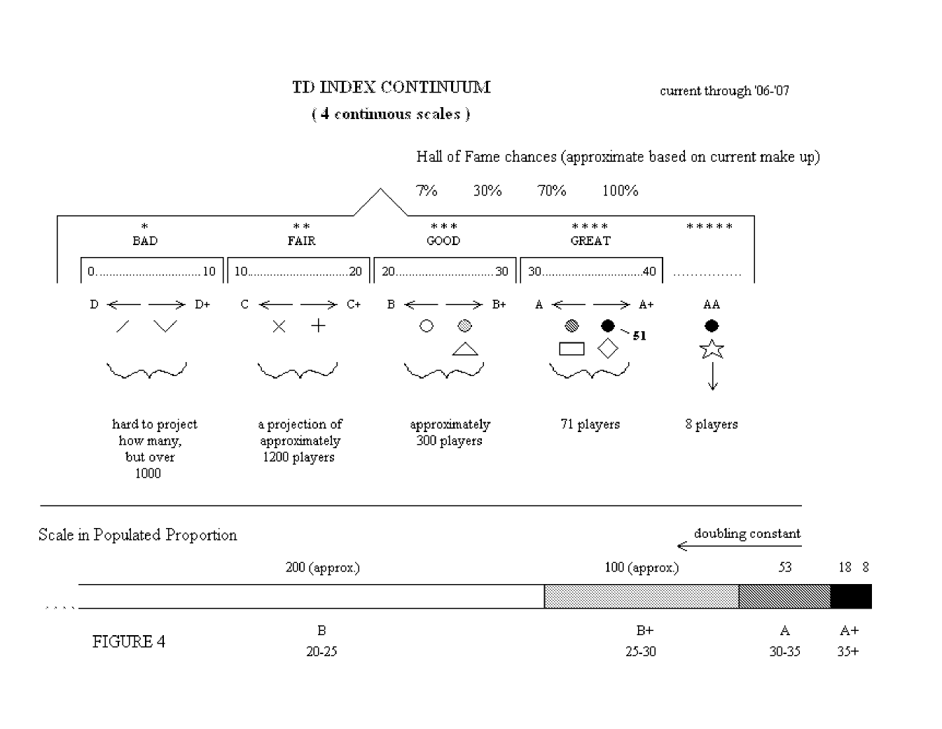

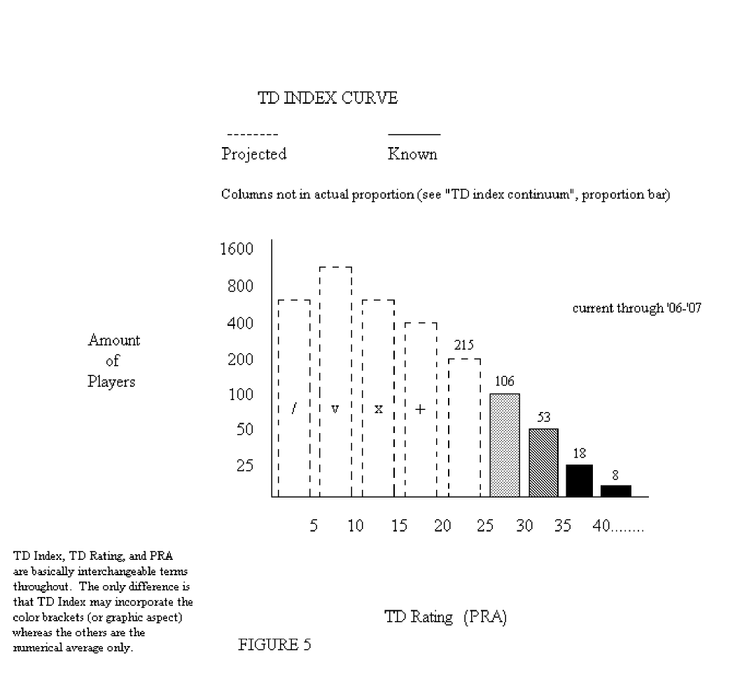

As shown in FIGS. 3-4, the method may further comprising the step of: providing a graphic according to the triple double index for the player. The graphic (51) may be a letter (as shown A, A+, B, B+, C, C+, D, D+), word (bad, average, good, great), stars (*, **, ***, ****) or any other graphic. There may also be step of: providing a descriptive according to the triple double index for the player. As shown in FIG. 3, the descriptive is bad, average, good and great. The descriptive may or may not be according to a grouping. For example, here the descriptive great is according to the grouping of a triple double rating between 30 and 40. There may also be a graphic according to the grouping. As shown, the graphic **** corresponds to great and a triple double rating between 30 and 40. As shown in FIG. 4, the method may further comprise the step of: providing a symbol/(60) according to the triple double rating between 0 and 5, V (62) may be between 5 and 10, X(64) may be between 10 and 15, +(66) may be a triple double rating between 15 and 20, O (68) may be a triple double rating between 20 and 25, triangle (70) may be a triple double rating between 25 and 30, square or rectangle (72) may be a triple double rating between 30 and 35, diamond (74) may be a triple double rating between 35 and 40, and a star (76) may be anything 40 or over, etc. It is envisioned that the triple double index and the triple double rating may be displayed on a statboard. Also, the graphic, descriptive, grouping and symbols may be displayed on a statboard. FIG. 2, for example, could represent a statboard showing the triple double rating (50), triple double index (51) and the secondary sum (52).

The grouping may be a numeric bracket (80, 82, 84 and 86). As shown, the grouping for the triple double rating between 0 and 10, may correspond to the “bad”, D−>D+, and *. The method may further comprise the step of dividing the triple double rating by a minutes value to provide a secondary sum. The triple double index may be displayed on a statboard. The triple double rating may also be displayed on a statboard. The secondary sum may also be displayed on a statboard.

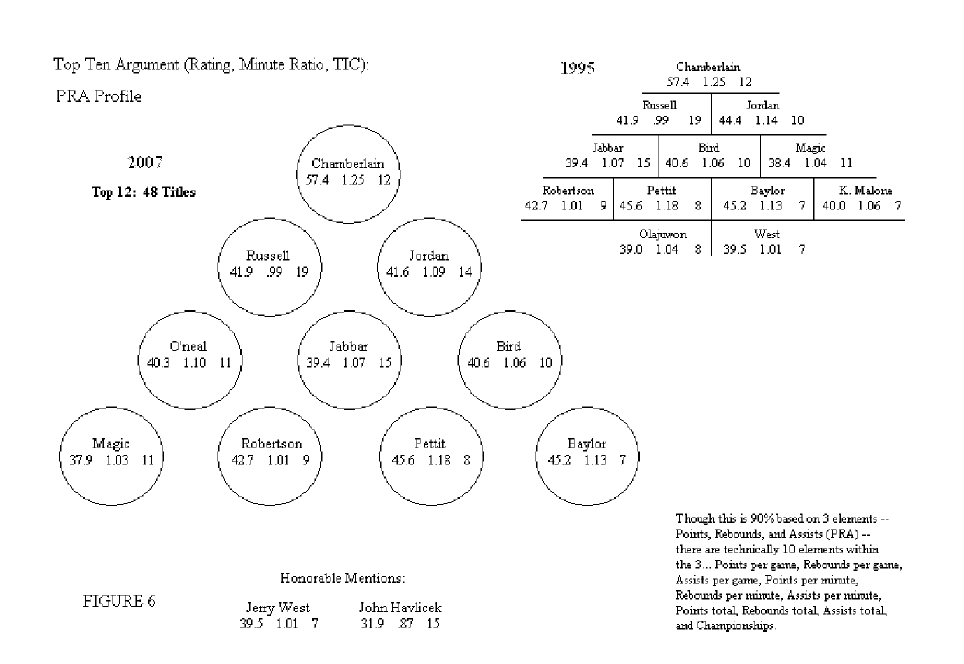

The method may be further comprising the step of multiplying the triple double rating by games to provide a total and displaying the total. When the total is at least 10,000 and the triple double rating is at least 10, the method may further comprise the steps of: a first digit of the total is added to a first digit of the triple double rating to provide a sum. There may also be the step of adding sum to the number of championships to provide a composite sum; and displaying the composite sum. There may be the steps of: summing a first digit of the total with a first digit of the triple double rating and to the number of championships to provide a composite sum; and displaying the composite sum (on a scoreboard or statboard for example). If the total is less than 10,000 and the triple double rating is at least 10, the total is set to zero and is added to a first digit of the triple double rating and to the number of championships to provide a composite sum. For example if the total is 9,999 (or less), the triple double rating is 26 and number of championships is 3, the composite sum would be 0+2+3=5. And if triple double rating is 9.9 or less instead of 26 the composite sum would be 0+0+3. When the triple double rating is less than 10 and the total is at least 10,000, the triple double rating is set to zero and is added to a first digit of the total and to the number of championships to provide a composite sum. When the total is less than 10,000 and the triple double rating is less than 10, the total is set to zero and the triple double rating is set to zero, and the zero is added to the zero to provide a sum that is equal to zero. The method may further comprise the step of: adding the sum to the number of championships to provide a composite sum; and displaying the composite sum. The term composite sum may be interchangeable with TIC (for Total, Index, Championships), as shown in FIG. 6. The triple-double rating, triple double index, graphic, symbol, descriptive, secondary sum, total and composite sum may be separately or in any combination applied to a single game, any part, or any group of games, and a single player or any group of players, and also displayed on a state board or any display medium. The method may further comprising the step of: adding the sum to the number of championships to provide a composite sum; and displaying the composite sum. The method may also comprise the steps of adding the sum to the number of championships to provide a composite sum; and displaying the composite sum. The triple-double rating, triple-double index, graphic, symbol, descriptive, secondary sum, total and composite sum may be separately or in any combination applied to a single game, any part, or any group of games, and a single player or any group of players, and also displayed on a stat board or any display medium.

It should be understood that the foregoing relates to preferred embodiments of the invention and that modifications may be made without departing from the spirit and scope of the invention as set forth in the following claims.

I claim:

1. A computer processor implemented method of rating and classifying players of a game, said method comprising the steps of:
evaluating a players rebounding proficiency to provide a rebounds per game for a player;
evaluating a players shooting proficiency to provide a points per game for a player;
evaluating a players passing proficiency to provide assists per game for a player;
summing said points per game, said assists per game and said rebounds per game for said player to provide a triple double rating;
grouping said triple double rating to provide a triple double index; and
displaying said triple double rating.

2. A method as in claim 1, further comprising the step of:
providing a graphic equating to said triple double index for said player.

3. A method as in claim 1, further comprising the step of:
providing a descriptive for said triple double index for said player.

4. A method as in claim 1, further comprising the step of:
providing a symbol equating to said triple double index for said player.

5. A method as in claim 1, wherein said grouping is a numeric bracket.

6. A method as in claim 5, further comprising a descriptive according to said grouping.

7. A method as in claim 5, further comprising a graphic equating to said grouping.

8. A method as in claim 1, further comprising the step of:
dividing said triple double rating by a minutes value to provide a secondary quotient.

9. A method as in claim 1, wherein said triple double index is displayed on a statboard.

10. A method as in claim 1, further comprising the step of:
dividing said triple double rating by a minutes value to provide a secondary quotient; and
displaying said graphic and said secondary quotient.

11. A method as in claim 1, further comprising the step of:
providing a symbol equating to said triple double index for said player.

12. A method as in claim 1, wherein said triple double rating, said triple double index, said graphic and said descriptive are displayed on a statboard.

13. A method as in claim 1, wherein said secondary quotient is displayed on a statboard.

14. A method as in claim 1, wherein said symbol is displayed on a statboard.

15. A method as in claim 1, further comprising the step of multiplying said triple double rating by games to provide a total and displaying said total.

16. A method as in claim 15, wherein said total is at least 10,000 and said triple double rating is at least 10, a first digit of said total is added to a first digit of said triple double rating to provide a sum.

17. A method as in claim 16, further comprising the step of:
Adding said sum to the number of championships to provide a composite sum; and
displaying said composite sum.

18. A method as in claim 15, wherein said total is less than 10,000 and said triple double rating is at least 10, said total is set to zero and is added to a first digit of said triple double rating to provide a sum.

19. A method as in claim 15, wherein said triple double rating is less than 10 and said total is at least 10,000, said triple double rating is set to zero and is added to a first digit of said total to provide a sum.

20. A method as in claim 15, wherein said total is less than 10,000 and said triple double rating is less than 10, said total is set to zero and said triple double rating is set to zero, and said total is added to said triple double rating to provide a sum.

21. A method as in claim 18, further comprising the step of: adding said sum to the number of championships to provide a composite sum; and displaying said composite sum.

22. A method as in claim 19, further comprising the step of: adding said sum to the number of championships to provide a composite sum; and displaying said composite sum.

23. A method as in claim 20, further comprising the step of: adding said sum to the number of championships to provide a composite sum; and displaying said composite sum.

24. A method as in claim 1, wherein said method is non-subjective and entirely statistically based.
